(19) United States
(12) Patent Application Publication
(10) Pub. No.: US 2026/0127284 A1
(43) Pub. Date: May 7, 2026

(54) Systems and Methods for Detecting Malicious Shellcode

(71) Applicant: Bitdefender IPR Management Ltd., Nicosia (CY)

(72) Inventors: Andrei V. LUTAS, Cluj-Napoca (RO); Ionel C. ANICHITEI, Cluj-Napoca (RO); Nicolae BODEA, Cluj-Napoca (RO)

(21) Appl. No.: 19/012,364

(22) Filed: Jan. 7, 2025

Related U.S. Application Data
(63) Continuation of application No. 19/012,315, filed on Jan. 7, 2025.
Application No. 19/012,315 is a continuation of application No. 19/012,275, filed on Jan. 7, 2025.
(60) Provisional application No. 63/715,705, filed on Nov. 4, 2024.

(51) Int. Cl. G06F 21/56; G06F 21/55

(52) U.S. Cl. CPC G06F 21/566; G06F 21/554; G06F 2221/034

(57) ABSTRACT

Kernel-mode security software detects a trigger event indicative of a specific stage in the lifecycle of a target software entity executing in user mode. In response, the security software identifies a target object residing in memory (e.g., loaded library, chunk of code, etc.) according to a current content of the user-mode call stack, and determines whether the target object is malicious. Various methods described herein detect malicious modifications of a loaded module, such as overload, stomping, and unhooking, among others. Other methods described herein detect dynamically swapped libraries and malicious shellcode, among others.

### CROSS-REFERENCE TO RELATED APPLICATIONS

This application is a continuation of U.S. patent application Ser. No. 19/012,315, filed Jan. 7, 2025, titled “Systems and Methods for Detecting Malicious Software Libraries,” which is a continuation of US patent application Ser. No. 19/012,275, filed Jan. 7, 2025, titled “Systems and Methods for Detecting Malicious Modifications of a Loaded Software Module,” which claim the benefit of the filing date of U.S. provisional patent application No. 63/715,705, filed on Nov. 4, 2024, titled “Anti-Malware Systems and Methods,” the content of all of which is incorporated by reference herein.

### BACKGROUND OF THE INVENTION

The invention relates to computer security, and in particular to protecting computers against malicious software (malware).

Malicious software affects a great number of computer systems worldwide. In its many forms such as computer viruses, worms, rootkits, and spyware, malware presents a serious risk to millions of computer users, making them vulnerable to loss of data and sensitive information, identity theft, and loss of productivity, among others.

Security software employs a variety of methods and strategies to combat malicious software. Some such methods try to match the contents of memory against a pre-determined library of malicious code snippets and patterns, commonly known as signatures. Other exemplary methods monitor the execution of selected software entities, looking for patterns of behavior that are indicative of malice.

Malware detection and mitigation face substantial technical challenges. Activities related to behavior monitoring and signature matching are computationally costly and may adversely affect productivity and user experience. Some components of the security software are themselves vulnerable to attack. Last but not least, malware constantly evolves to evade detection. Therefore, there is a persistent interest in developing novel, efficient, and robust anti-malware systems and methods.

### SUMMARY OF THE INVENTION

According to one aspect, a computer system comprises at least one hardware processor configured to, in response to an occurrence of a trigger event caused by an executing process, identify a region of memory used by the process, the region of memory identified according to a current content of a call stack of the process, and to further determine whether the region of memory is currently allocated for any software module used by the process. The at least one hardware processor is further configured, if the region of memory is not allocated for any software modules used by the process, to analyze a sequence of processor instructions stored within the region of memory to determine whether the sequence includes instructions referencing valid memory addresses, and in response, if the sequence does not include any instructions referencing valid memory addresses, to determine that the region of memory stores malicious software.

According to another aspect, a computer security method comprises employing at least one hardware processor of a computer system to, in response to an occurrence of a trigger event caused by an executing process, identify a region of memory used by the process, the region of memory identified according to a current content of a call stack of the process, and to further determine whether the region of memory is currently allocated for any software module used by the process. The method further comprises, if the region of memory is not allocated for any software modules used by the process, analyzing a sequence of processor instructions stored within the region of memory to determine whether the sequence includes instructions referencing valid memory addresses, and in response, if the sequence does not include any instructions referencing valid memory addresses, determining that the region of memory stores malicious software.

According to another aspect, a non-transitory computer-readable medium stores instructions which, when executed by at least one hardware processor of a computer system, cause the computer system to, in response to an occurrence of a trigger event caused by an executing process, identify a region of memory used by the process, the region of memory identified according to a current content of a call stack of the process, and to further determine whether the region of memory is currently allocated for any software module used by the process. The instructions further cause the computer system, if the region of memory is not allocated for any software modules used by the process, to analyze a sequence of processor instructions stored within the region of memory to determine whether the sequence includes instructions referencing valid memory addresses, and in response, if the sequence does not include any instructions referencing valid memory addresses, to determine that the region of memory stores malicious software.

### BRIEF DESCRIPTION OF DRAWINGS

The foregoing aspects and advantages of the present invention will become better understood upon reading the following detailed description and upon reference to the drawings where:

FIG. 1 shows a set of software components executing on a host system according to some embodiments of the present invention.

FIG. 2 illustrates exemplary components of a security application according to some embodiments of the present invention.

FIG. 3 shows an exemplary sequence of steps performed by a security application according to some embodiments of the present invention.

FIG. 4 shows an exemplary call stack and a set of exemplary software modules (e.g., libraries) referenced by the call stack, according to some embodiments of the present invention.

FIG. 5-A shows a structure of an exemplary software library, and exemplary modifications caused by a module overload attack according to some embodiments of the present invention.

FIG. 5-B illustrates exemplary modifications of a typical software library caused by a module stomp attack according to some embodiments of the present invention.

FIG. 5-C shows exemplary modifications of a typical software library caused by hooking and by a module unhook attack, respectively, according to some embodiments of the present invention.

FIG. 6 shows an exemplary sequence of steps performed by security software to detect malicious modifications of an executable module/library according to some embodiments of the present invention.

FIG. 7 shows another exemplary sequence of steps performed by security software to detect malicious modifications of an executable module/library according to some embodiments of the present invention.

FIG. 8 illustrates an exemplary sequence of steps carried out by security software to detect malicious shellcode according to some embodiments of the present invention.

FIG. 9 shows an exemplary hardware configuration of a host system programmed to execute some of the methods described herein.

### DETAILED DESCRIPTION OF THE INVENTION

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Any use of ‘or’ is meant as a nonexclusive or. Unless otherwise required, any described method steps need not be necessarily performed in a particular illustrated order. A first element (e.g., data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of processor instructions carrying out a task. Computer programs described in some embodiments of the present invention may be stand-alone software entities or sub-entities (e.g., subroutines, libraries) of other computer programs. A process is an instance of a computer program, such as an application or a part of an operating system, and is characterized by having at least an execution thread and a section of virtual memory assigned to it, the respective section comprising executable code. A page represents the smallest unit of virtual memory individually mapped to a physical memory of a host computer system. Computer-readable media encompass non-transitory media such as magnetic, optic, and semiconductor storage media (e.g., hard drives, optical disks, flash memory, DRAM), as well as communication links such as conductive cables and fiber optic links. Volatile media (e.g., DRAM) retain their content only while powered, in contrast to non-volatile media (e.g., magnetic hard disk, flash memory) whose contents persist when powered down. According to some embodiments, the present invention provides, inter alia, computer systems comprising hardware (e.g., one or more processors) programmed to perform the methods described herein, as well as computer-readable media encoding instructions to perform the methods described herein.

Embodiments of the present invention enable protecting a host system against malwarc. Exemplary host systems protected as described herein include personal computers, corporate mainframe computers, mobile computing platforms (e.g., laptop computers, tablets, smartphones), entertainment devices (e.g., TVs, game consoles), wearable devices (e.g., smartwatches, fitness bands), household appliances (e.g., smart lighting systems, door locks, thermostats, refrigerators), network appliances (e.g., routers, switches, etc.), and generally any other electronic device comprising a hardware processor and a memory.

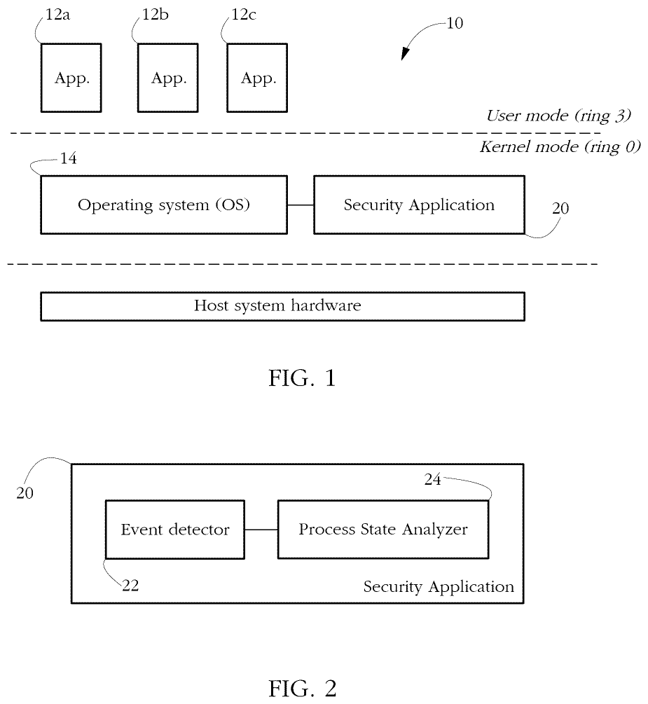

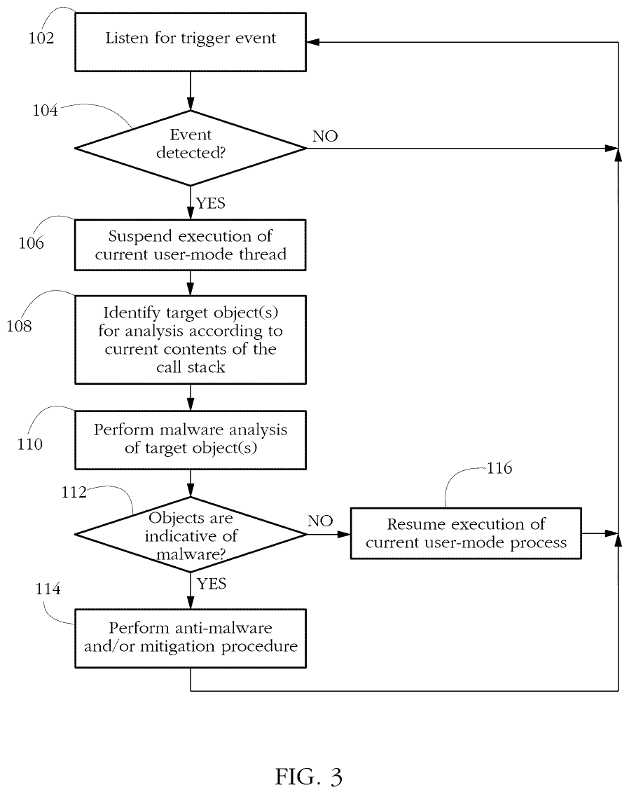

FIG. 1 shows exemplary software components executing on a host system 10 according to some embodiments of the present invention. FIG. 1 is rendered from the perspective of processor privilege levels, also known in the art as rings (on x86 processor platforms) and exception levels (ARM® processor platforms). A set of software applications 12a-c execute at a relatively low ‘user’ level of processor privilege, also known as ‘user mode’ or ring 3 on x86 platforms. Applications 12a-c generically represent any computer program, such as a browser, a productivity application (e.g., word processor, spreadsheet, etc.), a gaming application, a social media application, and an electronic communication application (e.g., email client, instant messenger, etc.), among others.

An operating system 14 executes at a more privileged level, commonly known as ring 0 or kernel mode on x86 platforms. OS 14 acts as an intermediary between user applications 12 and the hardware of host system 10 (such as memory, input and output devices, and communication interfaces, among others. Furthermore, OS 14 may carry out various administrative tasks collectively ensuring a smooth and efficient execution of applications 12, for instance manage process/thread scheduling and execution, construction and maintenance of data structures describing each executing entity (process, thread), manage memory allocation, memory mapping, loading an image of each computer program and its required dependencies into memory, pushing and popping data onto/off the stack, etc. Examples of OS 14 include Microsoft® Windows®, Linux®, Android®, and iOS®, among others.

In some embodiments, a security application 20 executes at a kernel level of processor privilege (ring 0, kernel mode) and is configured to protect host system 10 against computer security threats such as malware. Application 20 may be a standalone computer program or may be a part of a larger security suite comprising, for instance, software protecting users against online fraud and/or unsolicited communications (spam), and software providing encrypted communication channels (e.g., virtual private networking-VPN), among others. Security application 20 may comprise an event detector 22 communicatively coupled to a process state analyzer 24, the functionality of both of which is described in more detail below.

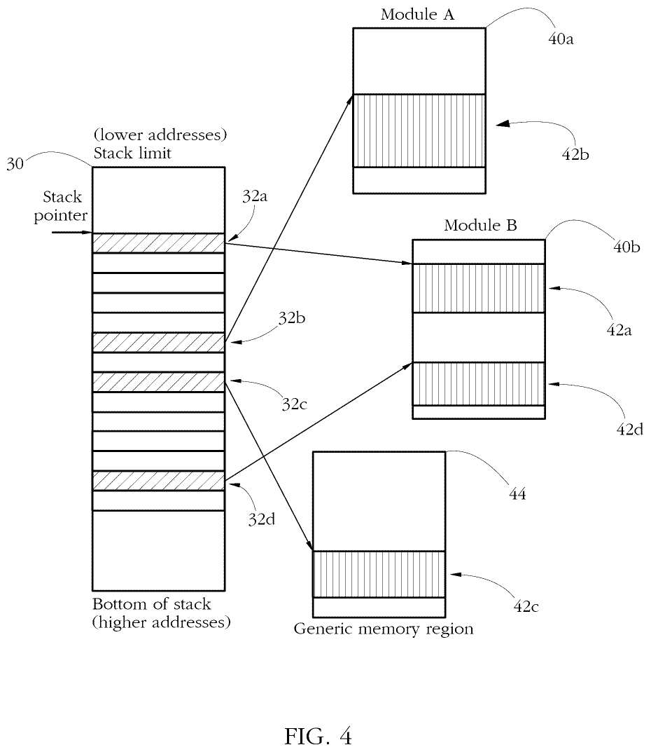

FIG. 3 shows an exemplary sequence of steps performed by application 20 to protect host system 10 against malware according to some embodiments of the present invention. Application 20 may execute concurrently with user applications 12a-c and other software and may listen by way of event detector 22 for specific events deemed relevant for computer security (a sequence of steps 102-104 in FIG. 3). In some embodiments, the detection of such events triggers a computer security analysis and therefore such events are herein called ‘trigger events’. Exemplary trigger events include events indicative of specific stages in the lifetime of an executable entity, the respective stages singled out for being particularly informative as to whether the respective executable entity is malicious or not. Such stages are herein deemed ‘inspection points’; some examples include loading an image of the respective process from non-volatile storage (e.g., hard disk) to memory, loading of an executable module (e.g., library) into memory, launching a process into execution, spawning a child process, creating a thread, connecting to a network socket, creating a pipe, accessing a registry key, and accessing a file, among others.

Event detector 22 may detect trigger events using any method known in the art of computer security. Preferred embodiments register selected event types with an event-reporting application programming interface (API) of OS 14. For instance, in Windows®, a driver may subscribe to be notified by the kernel in response to specific events, via a mechanism known as ‘kernel callback’. Alternative methods may involve hooking, a generic term for intercepting function calls, messages, or events passed between software components. One exemplary hooking method comprises altering the entry point of a target function by inserting an instruction redirecting execution to a second function. Following such hooking, the second function may be executed instead, before, or after the target function. For instance, when a process calls for some OS functionality, e.g. to allocate a section of memory, or to write something to a disk file, the respective processor instruction calls a user-mode API such as kernel32.dll or ntdll.dll on Windows® platforms. To detect such a call, some embodiments may alter the respective function to redirect execution to event detector 22, thus notifying security application 20 of the call.

However, performing the interception of a trigger event from a user level of processor privilege may result in contaminating the call stack with items pushed on the stack by the hook functions performing the actual interception. To avoid unwanted modifications to the call stack, some embodiments may prefer intercepting trigger events at kernel level and/or system call level, over intercepting at user level. Alternatively, in some embodiments, the malware analysis of the target thread/process (see below) may be performed by a second thread distinct from the target thread, the second thread executing concurrently with the target thread, but in kernel mode. For instance, the second thread may be synchronized with the target thread for the duration of the analysis, so that the target thread is not contaminated by software components performing the interception and/or the actual analysis.

In response to detecting a trigger event, in a step 106 some embodiments suspend execution of the target thread for the duration of malware analysis, thus freezing the current state of the respective process, i.e., the state at the current inspection point. The state of a process herein denotes the current contents of its memory space, including current values of all variables, the stack, and all executable modules/libraries loaded by the respective process.

Process state analyzer 24 can then examine the state of the respective process for indicators of malice. However, the state may comprise a vast data structure and inspecting such high volumes of data may be computationally expensive, affecting user experience. Some embodiments rely on the observation that practically all software components that are relevant and consequential for the current inspection point (i.e., current stage within the life cycle of the current user-mode process) are referenced by the call stack. Stated otherwise, any malicious software executing at or immediately following of the current inspection point most likely resides within components referenced by addresses currently present on the stack. Some embodiments of the present invention explicitly use this observation to identify a set of relevant software objects (libraries, etc.) for analysis according to a current content of the user-mode call stack, thus vastly reducing the search space and computational expense associated with malware detection.

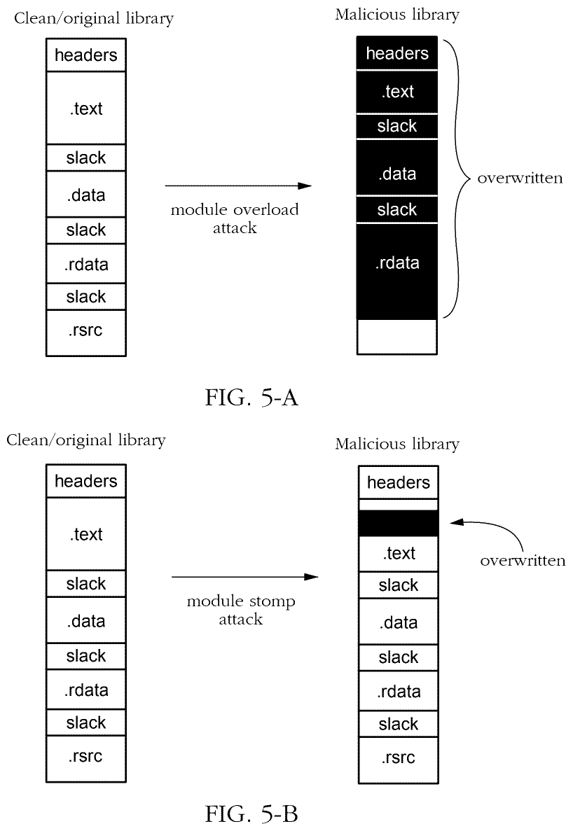

FIG. 4 shows a section of memory occupied by an exemplary call stack 30 according to some embodiments of the present invention. Stack 30 is divided into individual addressable memory units, the size of which is dependent on architecture. For instance, on 32-bit platforms, each illustrated stack unit represents 4 bytes of memory space. Stack 30 is located at a memory address commonly known as the stack pointer, which on x86 platforms is stored in the ESP/RSP register of the hardware processor of host system 10. Each stack unit stores a distinct stack item, which typically comprises an address of a function or a parameter value passed to the respective function. Stack items comprising addresses are herein called stack references. In the example illustrated in FIG. 4, references 32a-d include memory addresses of code chunks 42a-d (e.g., various functions/subroutines and/or shellcode) respectively.

In modern programming paradigms, software is built from a collection of building blocks or modules comprising executable code. Exemplary modules include a main executable of a process (such as an EXE file in Windows®) and a library (such as a dynamic-linked library-DLL in Windows®), among others. Similar kinds of modules may be identified in host systems 10 executing operating systems such as Linux®, or MacOS®. The main executable module of a process typically comprises the first processor instruction of the respective process, executed when the respective process is launched. Libraries are self-contained sections of code implementing various functional aspects of a program. For instance, the NTDLL. DLL library includes a collection of functions implementing various aspects of the Windows® OS, such as a system call interface, among others. Shared libraries may be used independently by more than one program. Modules may be loaded and/or unloaded to/from memory prior to and/or during execution of the respective process.

Each function/code chunk 42a-d called from the stack typically forms a part of a software module (e.g., software library) loaded into memory, such as exemplary modules 40a-b in FIG. 4. Some embodiments explicitly use this observation to identify modules 40a-b according to a content of the call stack, e.g., according to stack references 32a-d. For instance, some embodiments identify modules 40a-b by calling specific APIs of OS 14, e.g., memory mapping utilities that allow identifying software components residing in the vicinity of each stack reference 32a-d. Alternatively or additionally, some embodiments identify modules 40a-b by parsing specific data structures used by OS 14 to represent and manage currently executing processes and/or threads (e.g., EPROCESS, ETHREAD, and/or virtual address descriptor-VAD data structures in Windows®). Such structures typically include a virtual and/or physical memory address (also termed base address) of each loaded module. By correlating the respective base addresses with stack references 32a-d, some embodiments determine which module 40a-b each stack reference 32a-d points to.

Some sophisticated malware attacks inject code into regions of memory which are not currently storing parts of a software module/library, as illustrated by generic memory region 44 in FIG. 4. The respective memory region may currently store an image of a non-executable object (e.g., a PDF file, a movie, etc.), or may be currently empty. The injected code commonly comprises shellcode, the detection of which is described in detail below. Some embodiments use stack references such as exemplary reference 32c to efficiently identify memory content for analysis, such as exemplary code chunk 42c in FIG. 4.

In a step 108 (FIG. 3), state analyzer 24 identifies a target object for analysis according to the contents of the call stack. The target object may include a loaded module identified as described above, for instance, modules 40a-b in FIG. 4. A further step 110 may then carry out a malware analysis of the content of the identified module(s) 40a-b using any of the methods detailed below. When the analysis does not indicate a suspicion of malice (a step 112 returns a NO), a step 116 may resume execution of the current user-mode process. If malware is detected, application 20 may carry out anti-malware or mitigation procedures. For instance, step 114 may comprise blocking the creation or launch of the malicious process, terminating the compromised process, etc. Some embodiments also harvest identified code chunks 42a-d or entire modules 40a-b for further analysis and development of malware-indicative signatures and/or malware detection strategies.

Some exemplary malware-detection procedures applied to identified target objects include module integrity checks, detection of malicious libraries, and detection of shellcode, among others.

### Module Integrity Checks

In operating systems such as Windows®, every process contains one or more executable modules 40a-b loaded into its address space and performing various functions. Modules 40a-b include OS libraries, application-specific modules, and possibly 3rd party modules (e.g., printer modules, encryption modules, anti-malware modules, etc.). Legitimate code is almost always executed from such modules, with some exceptions such as just-in-time (JIT) compiled code or shellcode which are located in private memory. Therefore, execution of code from outside a currently loaded executable module is typically considered suspect.

Sophisticate malware may attempt to evade detection by hiding inside what appears to be clean, legitimate modules loaded by a respective application. Some embodiments address this type of attack, effectively detecting situations wherein legitimately loaded modules have been maliciously altered. Checks for such alterations are performed during critical stages in the lifecycle of a process, such as process creation, image load, thread creation or opening of sockets. At these stages, herein called inspection points, process state analyzer 24 determined whether the trigger event indicative of the respective inspection point occurred in a malicious context. Some embodiments carry out such analysis according to a current content of the user-mode call stack. Stack 30 (FIG. 4) contains the chain of function calls that have led to the occurrence of the detected trigger event (step 104 in FIG. 3), and generally identifies software entities participating in or relevant to that trigger event/inspection point. Some embodiments analyze each stack reference 32a-d to identify a loaded module 40a-b pointed to by the respective stack reference. Some embodiments may then inspect the identified loaded module(s) to determine whether it has been maliciously altered by an attacker.

Each module 40a-b is typically stored as a file on non-volatile storage media of host system 10. When the respective module is loaded, a loader/dynamic linker component of OS 14 copies at least a part of the content of the respective file into volatile memory (RAM), thus creating a memory image of the respective module, which is then used in execution. Malicious modifications are typically made to the memory image, i.e., following loading of the respective module into volatile memory. Conventional anti-malware methods comprise comparing the memory image and disk image of a respective module to detect unauthorized module modifications. Such methods involve I/O calls and are therefore typically slow. In contrast, some embodiments of the present invention rely solely on the memory image of a loaded module and on module-specific metadata stored and managed by the OS.

Once loaded into memory, each module is described by data structures constructed and maintained by OS 14 (e.g., VADs, EPROCESS, PEB, etc.), comprising various metadata that indicate, among others, the location/path of the module on disk, the memory address where it was loaded, etc. The memory image of the module itself consists of multiple sections, each with a clear role. The content and format of a module/library are OS-specific, but all formats are analogous in the sense that they generally encode the same type of information. In particular, the currently most popular format known as a Portable Executable (PE) includes the following sections:
a. Headers—the module headers are like a map for the entire module, indicating the order in which various sections are stored, size of each section, etc.;
b. Code sections—these contain the actual executable code implementing the functionality of the respective module. In PE modules, code is generally contained within a. TEXT section;
c. Data sections—these encode nonexecutable data that is used by the module;
d. Imports-comprising a structure telling OS 14 what dependencies the module has, and what symbols are used from other modules;
e. Exports—encoding exported symbols usable by other modules;
f. Exception handlers—encoding information about how exceptions arising during execution of each function of the respective module should be handled. In PE modules, exception handling data is stored as an exception table typically contained within a. PDATA section;
g. Resources—encoding information about resources such as images, icons, etc.;
h. Relocations—comprising information about absolute addressing used within the respective module; such information is used by the loader/dynamic linker of OS 14 in code relocation/rebasing procedures. In PE modules, relocation data is stored as a relocation table typically contained within a. RELOC section.

An attacker may target one or more such sections and data structures, by altering them to facilitate the hiding and execution of malicious code. Some examples of malicious modifications include module overload, module stomping, and module unhooking.

i. Module Overload

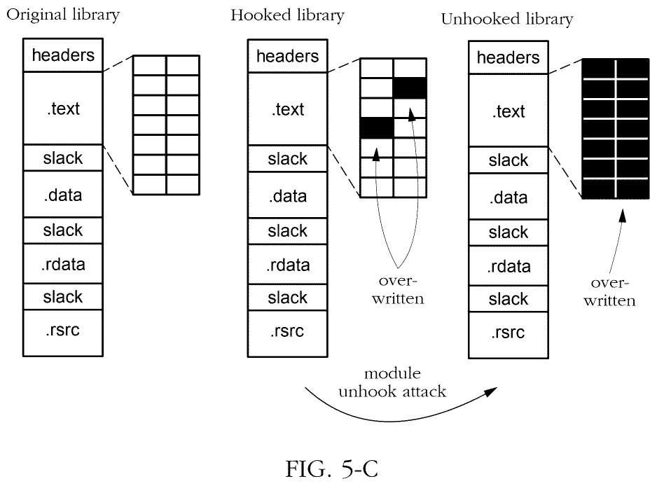

This type of malicious modification of a loaded module is illustrated in FIG. 5-A, and includes overwriting the section of memory occupied by the clean module with a new data structure comprising a complete and functional malicious module: substitute headers, substitute code sections, data sections, etc. When the malicious substitute module is smaller than the original clean module (as illustrated), at least a part of the original data may be left unchanged. Furthermore, the attack leaves the OS-managed metadata describing the module intact, thus tricking the OS into reporting the characteristics of the original, clean module to any API that uses such characteristics.

Some embodiments detect a module overload by comparing the size of the respective module (as specified in the header section of the current memory image of the respective module) to the size of the memory section actually allocated by OS 14 for the respective module (obtained for instance by querying a memory management API of OS 14). An exemplary embodiment implemented on a Windows platform may compare the current content of the SizeOfImage field of the IMAGE_OPTIONAL_HEADER field of the module headers to the OS-allocated size. In some embodiments, a value smaller than that of the original memory allocation indicates malicious manipulation.

Some OSs may allocate slightly more memory than required to load a module. For instance, some versions of Windows® may allocate up to 4 extra memory pages for selected modules such as NTDLL.DLL, among others. Such additional allocations may cause some embodiments to produce false positives, i.e., to incorrectly classify a legitimate, benign module as malicious. To avoid such situations, some embodiments may determine whether a target module is malicious according to the amount of difference between the OS-allocated size and the size declared in the header of the memory image of the respective module. For instance, some embodiments may classify the respective object as malicious if the difference exceeds predetermined threshold (e.g., 4 memory pages), and as benign otherwise.

Alternatively or additionally, some embodiments determine whether memory pages storing the current version of the respective module are dirty (i.e., overwritten). In other words, some embodiments will check all memory pages up to the size declared in the current header. In module overload attacks, all such pages are dirty/overwritten. Otherwise, at least some memory pages storing read-only code or data sections would not be dirty. In practice, when checking if the memory space storing the module is dirty, certain optimizations may be used. For example, to increase efficiency, some embodiments may check only the first page of each section of the module; this works because all modules should contain at least one non-writable section (the one containing the code), so finding that all sections have dirty pages is strongly indicative of malicious manipulation.

Some embodiments further rely on the observation that using each of the above methods in isolation may be insufficient for detection or may produce false positives. Some OSs including some versions of Windows® may allocate extra memory for a module image, which may lead to situations where the size declared in the module header and the size allocated by the OS do not match, even for un-tampered, benign modules. Conversely, only checking for dirty pages may lead to false positives especially in packed modules, which unpack following loading and thus occasionally overwrite their entire allocated memory space. Some embodiments therefore determine that a target module is malicious if there is a mismatch in the size of allocated memory and further if the memory space storing the respective module is dirty.

ii. Module Stomping

This type of malicious modification of a loaded module is illustrated in FIG. 5-B, and comprises injecting code into an already loaded module, without altering its headers or original section layout. Variations include replacing a target code chunk (see e.g., chunk 42a of module 40b illustrated in FIG. 4) such as an individually referenced function, replacing the contents of a single memory page, and replacing multiple functions/chunks over multiple memory pages. The injected code typically comprises shellcode. To preserve execution privileges of the stomped module, the injected code is typically injected into a code section of the original module (e.g., a .TEXT section), while other sections/structures of the respective module are left intact.

Stomp checks may be performed on every memory page referenced by the call stack, and only if that page is dirty. The same page will not be checked twice within the same context (i.e., at the same inspection point). The performed checks will corelate the information in the PE structures with the code discovered in each page present on the call stack. Discrepancies may indicate a malicious modification (stomping).

Details of the detection method may differ according to processor architecture and version of OS 14. In embodiments executing on a version of OS 14 that implements dynamic loading/linking of libraries (such as some 32-bit versions of Windows®, among others), analyzer 24 may detect stomping according to a content of a relocation table. In embodiments using the PE architecture, the relocation table is typically found in a .RELOC section. Otherwise, an address of the relocation table may be determined according to selected headers of the respective module.

It is common for 32-bit modules to include absolute memory references. For instance, the disk image of a selected module may include the instruction:
MOV eax, dword ptr [0x48b070],
which includes a reference to the absolute memory address 0x48b070 (address references are indicated in square brackets). However, in dynamic loading/linking and more sophisticated memory management strategies such as address space layout randomization (ASLR), the respective module may be loaded at an arbitrary location in memory. Therefore, upon loading the respective module into memory, the loader and/or dynamic linker component of OS 14 may replace each such absolute address with a respective runtime address. For instance, in the memory image of the respective module, the above instruction may read:
MOV eax, dword ptr [0x6648b070],
wherein the address 0x6648b070 is the runtime correspondent of absolute address 0x48b070. To assist the OS with the process of changing absolute addresses into runtime ones (commonly called rebasing or relocation), the respective module/library may include a relocation table. A relocation table herein comprises a list of entries, each indicative of a relocation of an address included in the code of the respective module. Each entry of the relocation table may comprise a pointer (e.g., relative virtual addresses) indicating where the reference to each respective absolute address is located within the respective module. In the example above, one entry of the relocation table may indicate where the reference ‘[0x48b070]’ is stored relative to a module's base address. Relocation table entries enable the loader and/or dynamic linker of OS 14 to locate addresses that need to be modified within the respective module. Following the loading of the respective module into memory, relocation table entries further enable other software to determine which addresses included in the respective module were relocated.

Some embodiments of the present invention rely on the observation that, since most malicious modifications of a module/library occur following loading of the respective module/library into memory, the injected code will overwrite at least some of the memory locations that used to store relocated addresses, i.e., memory locations indicated by the relocation table. Some embodiments may thus walk the relocation table/list of pointers and check the current content of a memory location pointed to by each entry. If the respective content is likely to have been overwritten, some embodiments determine that the respective module has been modified after loading and is therefore likely to be malicious.

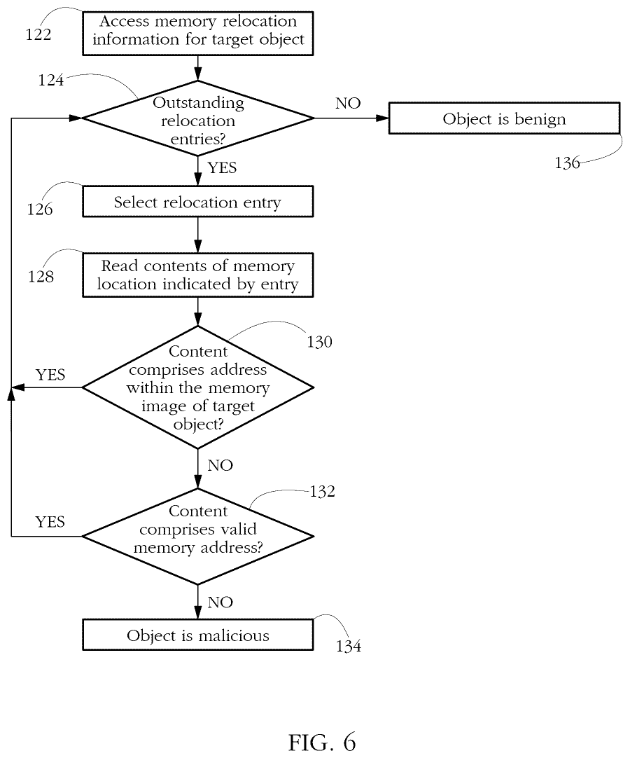

FIG. 6 shows an exemplary sequence of steps carried out by process state analyzer 24 to detect module stomping according to some embodiments of the present invention. The illustrated sequence may be executed as part of step 110 in FIG. 3. A step 122 may access memory relocation data available for the respective target object (module/library). In embodiments implemented on computing platforms that use the PE format for executables, step 122 may comprise accessing the ‘Relocations’ section (e.g., .RELOC) of the memory image of the respective module/library. Alternatively, some embodiments may read relocation data from an address indicated to by the data directory header of the memory image (e.g., IMAGE_DATA_DIRECTORY, in some versions of PE).

Next, a sequence of steps 124-126 may enumerate all relocation entries. For each such entry, a step 128 may read the contents of a memory location indicated by the respective entry. As described above, normally the respective location stores a memory address modified by OS 14 upon loading/linking the respective module. In a step 130 state analyzer 24 determines whether the respective content comprises a memory address within the memory space allocated for the respective module. When YES, analyzer 24 returns to steps 124-126 to select another relocation entry.

If step 130 returns a NO, in some embodiments a step 132 further determines whether the content indicated by the relocation entry comprises a valid memory address, relying on the observation that there may be situations wherein the modified address points outside the current module. However, the logic of memory relocations requires that the respective content comprise a valid memory address. Memory addresses are herein deemed ‘valid’ if they point within a section of memory allocated by OS 14, i.e., addresses for which OS 14 currently has a virtual-to-physical translation. An exemplary check for validity may comprise attempting to access the respective memory address and determining a result of the respective attempt (accessing an invalid address will typically generate an exception). An alternative embodiment may input the respective address to a memory management API of OS 14, which will return an error message if the address is invalid.

If step 132 returns a NO, in a further step 134 some embodiments determine that the current target object (module/library) is malicious. Conversely, when all outstanding relocation entries have been reviewed and there is no indication of malicious overwriting, a step 136 determines that the respective module/library is benign.

A more sophisticated embodiment geared toward avoiding false positive detections may count apparently modified relocated entries, i.e., entries for which both steps 130 and 132 return a NO, and determine whether an attack has occurred according to the respective count, or according to a proportion of modified relocated entries relative to all relocation table entries for a respective page. In one such example, a module is deemed malicious if at least one memory page hosting it contains at least 8 relocated entries, at least 50% of which are apparently modified.

In contrast to the methods described above, which detect module stomping according to memory relocation data, some alternative methods may rely on exception handling data stored in the memory image of the respective target object (module/library). Such methods may be suited to processor architectures and OS versions (e.g., some 64-bit versions of Windows®) that do not use memory relocation when loading/linking modules.

The memory image of a module/library typically includes an exception table comprising instructions for handling exceptions occurring during execution of the respective module. In modules structured according to the PE format, the exception table includes a series of entries, each entry corresponding to a distinct function of the respective module/library and including function-specific exception handling instructions. For instance, in some 64-bit versions of Windows®, each function is described by a respective RUNTIME_FUNCTION entry of the exception table.

Typical exception handling includes stack unwinding. Stack unwinding herein denotes the set of operations performed by OS 14 in order to bring the call stack and/or processor registers back into a state that they were in prior to the execution of the function that caused the respective exception. Stated otherwise, stack unwinding must counter the changes made to the stack and/or processor registers by calling the function that caused the respective exception. Such changes are made by a dedicated sequence of processor instructions located at the very beginning of the respective function, collectively known as the function prologue. Among others, the function prologue moves the current stack pointer into the EBP/RBP register, grows the stack pointer to make room for any local variables of the respective function, and pushes the content of nonvolatile (callee-saved) registers onto the stack.

Some embodiments rely on the observation that for a successful stack unwind, for each function the stack unwind instructions must precisely match instructions of the prologue of the respective function. Any mismatch may indicate a malicious modification of the respective module/library. In one such example, the exception handling information for a selected function may include:

Unwind version: 1
Unwind flags: None
Size of prologue: 0x20
Count of codes: 12
Unwind codes:
20: SAVE_NONVOL, register=rsi offset=0x68
20: SAVE_NONVOL, register=rbp offset=0x60
20: SAVE_NONVOL, register=rbx offset=0x58
20: ALLOC_SMALL, size=0x20
1C: PUSH_NONVOL, register=r15
1A: PUSH_NONVOL, register=r14
18: PUSH_NONVOL, register=r13
16: PUSH_NONVOL, register=r12
14: PUSH_NONVOL, register=rdi
...

According to this exemplary unwind data, the prologue of the respective function is 0x20 bytes long, and should contain the following instructions at the indicated offsets with respect to the base address of the respective function:

Offset 0x13: PUSH rdi
Offset 0x14: PUSH r12
Offset 0x16: PUSH r13
Offset 0x18: PUSH r14
Offset 0x1A: PUSH r15

wherein processor registers rdi, r12, . . . , r15 are known in the art as callee-saved or nonvolatile for storing values used by the caller of the current function, as opposed to the function itself. Some embodiments check the content of memory located at the indicated offsets and if the respective content does not match the expected opcode, determine that a malicious modification has occurred.

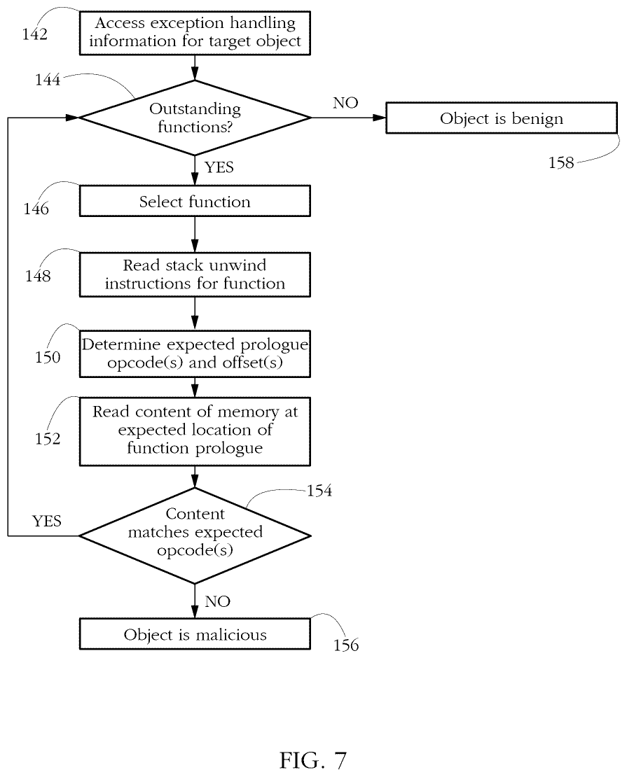

An exemplary sequence of steps implementing module stomping according to some embodiments of the present invention is illustrated in FIG. 7. The illustrated sequence may be executed as part of step 110 in FIG. 3. A step 142 may access exception handling data available for the respective target object (module/library), for instance within the .PDATA section, or at an address indicated by the data directory header of the memory image (e.g., IMAGE_DATA_DIRECTORY, in some versions of PE).

As sequence of steps 144-146 may enumerate functions of the respective module, for instance as distinct entries of the exception table. For each function, a step 148 may then access any function-specific stack unwind information. For instance, each RUNTIME_FUNCTION structure may specify, among others, the size of the function prologue, which callee-saved registers are saved on the stack and how much memory is allocated for the local variables of the respective function. A further step 150 may determine according to the respective stack unwind information a set of expected prologue instructions (e.g., opcodes) and their expected memory locations (e.g., offsets with respect to a base address of the respective module or function), based on the observation that stack unwinding should exactly counter the effect of the respective prologue instructions. A step 152 may read the content of memory at the expected location(s), for instance within the .TEXT section of the respective PE where the actual code of the respective function is expected to be located.

In a step 154, state analyzer 24 may compare the expected prologue instructions/opcodes determined in step 150 with the actual content of memory at the respective locations. A mismatch may cause some embodiments to determine that the respective module/library is malicious (a step 156).

The methods above may be performed at specific inspection points (process creation, image load, etc.). The described detection algorithm may be performed for every memory page referenced by the call stack, if that page is dirty (overwritten), and if the respective page wasn't scanned already. Each suspicious page may be reported, and its contents may be further scanned using conventional anti-malware engines (e.g., signature matching, etc.).

iii. Module Unhooking

This type of malicious module modification is illustrated in FIG. 5-C and comprises an attempt to remove code hooks previously placed on the respective module. Such hooks are generally placed by computer security software in specific OS libraries which are particularly important for security, such as NTDLL.DLL in Windows®, for instance to enable detection of various events or to analyze various data in the memory context of a respective process. By removing such hooks, code unhooking attacks therefore ensure that at least some of the measures relied upon by computer security software are no longer active. Code unhooking typically comprises restoring the current. TEXT section of a module to its original state (i.e., preceding hooking), for instance by overwriting the respective section with a version read from disk.

In FIG. 5-C, black regions indicate memory pages modified following the loading of the respective module. In the hooked module, only a selected subset of pages have been overwritten, indicating the few locations where the hooks were placed. In contrast, a module unhook attack overwrites all memory pages of the .TEXT section.

Some embodiments detect code unhooking attacks by iterating, sequentially, every page belonging to the .TEXT section of a target module, and checking whether it is dirty or not. If the section has been unhooked via conventional methods, then all pages inside the section will be dirty. If, instead, the section has not been unhooked, we will find at least one page that isn't dirty. Some embodiments therefore stop the sequential scan as soon as a non-dirty page is found; such a situation indicates that unhooking has NOT occurred.

Detecting if a page of memory P is dirty (modified or no longer shared with other processes) can be done in any manner known in the art. One such exemplary method checks the associated page table entry for page P and determine whether its dirty bit is set—this works only until the page is swapped out, or until the OS decides to clear that flag; this is not entirely reliable, and it also requires accesses to the page tables. Another exemplary method applicable on a Windows® platform uses the ZwQueryVirtualMemory function of OS 14 with the MemoryWorkingSetExInformation query code—this returns, among others, information regarding the sharing status of that page. If page P is no longer shared, it will have the Shared indicator set to false.

### Detection of Malicious DLLs

Every running process typically loads multiple modules/libraries, each embodying a specific type of functionality (e.g., electronic communication, web browsing, cryptography, etc.). Attackers sometimes inject malicious DLLs into legitimate processes to perform various malicious tasks, such as stealing sensitive information, hiding other malicious components, or otherwise altering the functionality of the original program. The attackers may try to make such malicious DLLs appear legitimate or hide them altogether. A classic example of a technique used to inject malicious DLLs inside a process is the ‘reflective DLL method’, wherein the respective DLL is manually loaded by the attacker into the memory space of a target process. Since such loading bypasses the normal loading/linking mechanisms of OS 14 and therefore does not create and register the required metadata, the respective DLL is typically invisible to OS 14.

To address such attacks, some embodiments use the stack to identify a memory region that presumably stores a module/library (see step 108 in FIG. 3), and then look for discrepancies or mismatches in information available about the respective module/library from several distinct sources. Some such sources include:
a) The memory image of the module itself, with all the code and data that it contains;
b) OS-managed metadata describing the respective module/library, stored in user-mode data structures such as the Process Environment Block (PEB) in Windows®-such metadata may include, for instance, the address of the memory image, size of the module, location/path of the non-volatile/disk image of the module, etc.
c) Memory allocation information, accessible in kernel mode by calling specific memory management APIs of OS 14.
   i. Detection of a Swapped DLL

A particular type of attack known under the name ‘Swappala’ comprises unmapping a section of a clean, legitimate module, and then mapping a corresponding section of the malicious module over it. Mapping a set of data herein denotes allocating a section of volatile memory (RAM) for the respective data and then copying it from the current location (either volatile memory or non-volatile storage) into the allocated section of memory. For instance, mapping a disk file to memory comprises allocating memory for storing the contents of the respective file and actually copying the contents of the file into the allocated memory. Unmapping then refers to the process of releasing the allocated section of memory.

The malicious module section is deliberately crafted to have at least some of the characteristics of the swapped section (e.g., size). Following the swap, any malicious actions will seem to be performed by the clean module, since most OS records/metadata, such as PEB loader lists, are consistent with the original, clean module. Once the malicious actions have been performed, the attacker can unmap the malicious code and remap back the original code, thus erasing his/her tracks.

To detect a swap attack, some embodiments of analyzer 24 perform a set of checks for each reference on the call stack. One check performed according to some embodiments comprises determining the type of allocation specific to region X of memory referenced from the call stack. Such embodiments rely on the observation that the memory region occupied by an unmodified module is typically of a type ‘image’. However, if a malicious module is later mapped onto the already loaded module, the type of allocation of the respective memory region will change to ‘map’ or ‘private’. Some embodiments therefore interpret the ‘map’ and ‘private’ allocation types as an indicator of malice.

Another check performed according to some embodiments comprises determining whether process-specific data structures of OS 14 currently have metadata characterizing the identified memory region X, e.g., metadata indicating whether there are any loaded modules in the respective memory region. For instance, in some versions of Windows® the PEB may store the base address and size of all modules loaded by the current process, which allows determining whether region X hosts any loaded module. Some embodiments interpret the existence of metadata associated with the respective memory region as indicative of malice.

Yet another check performed according to some embodiments relies on the observation that legitimate modules/libraries are loaded into memory from non-volatile storage (e.g., a disk file). However, malicious modifications of the respective modules are typically not backed by a hard copy, but instead mapped from memory. Some embodiments therefore determine an identifier (e.g., filename, location/path) of a file/nonvolatile image of the current module, for instance by calling a memory management function of OS 14. For instance, In Windows®, a query to ZwQueryVirtualMemory with the MemoryMappedFilenameInformation code will return a name/path of the file mapped to the respective memory region, or STATUS FILE INVALID (0xc0000098) if no such file exists. Some embodiments interpret the nonexistence of a file as indicative of malice.

In some embodiments geared at avoiding false positives, a verdict of malice will be issued only if all individual checks above are indicative of malice. In response to a verdict of malice, the content of region X may be harvested and further analyzed using conventional anti-malware methods.

To minimize computational costs, the three security checks described above may be executed in the presented order. For instance, some embodiments check for OS metadata only in response to determining that the allocation type of region X is not of type ‘image’. Some embodiments further check for a disk file mapped to region X only if the second check reveals the presence of OS metadata related to region X.

ii. Detection of an Unsigned DLL

Many modern operating systems protect some processes by preventing them from loading unsigned modules/libraries. However, in some circumstances, attackers may abuse various vulnerabilities to load unsigned DLLs inside such protected processes.

Some embodiments rely for detection on information/metadata that the OS already has stored in various data structures that are used for characterizing the respective process and/or module. For instance, Windows®-based embodiments may use information stored in the EPROCESS data structure or inside the memory image of the module itself. A determination of whether a DLL is properly signed typically requires at least two data items:
1. The required DLL signature level for a target module—this can retrieved for instance from the EPROCESS structure via an exported API called PsGetProcessSignatureLevel, which indicates the minimum signature level expected for a DLL, and/or the minimum signature level for the main executable of the respective process.
2. The actual signature level of a loaded image—this can be obtained for instance using the ZwQueryVirtualMemory API, with the MemoryImageInformation query code.

Some embodiments detect a maliciously loaded library by comparing the required and actual signature levels for a target module/DLL. A mismatch typically indicates malware, and may at least trigger additional investigations.

The illustrated method may be performed selectively, only for protected and ‘protected light’ processes. Some embodiments perform the comparison of signature levels for every module references from the call stack. Each unsigned DLL may be reported and further scanned using conventional anti-malware engines.

### Detection of Malicious Shellcode

Shellcode herein denotes self-contained code that can be loaded and executed at an arbitrary address in memory. Shellcode is not part of a regular executable file and doesn't use libraries or other high-level programming structures. Regular anti-malware signatures are rarely sufficient to detect shellcode, since the attackers can easily alter the code to evade detection. Conventional approaches to shellcode detection comprise static methods (such as signature matching) and dynamic methods that rely on observing the behavior of the respective code, as revealed for instance by emulation.

Shellcode detection as described herein is performed at specific inspection points (specific stages in the lifecycle of a process) and relies on the observation that if shellcode were to be involved in the respective stage of execution of the current process, a reference to it would be present on the call stack. Therefore, some embodiments analyze each call stack reference to determine if it points to a chunk of shellcode. Such shellcode may hide inside a data file or may comprise generic shellcode. The exemplary methods described below are not mutually exclusive.

i. Detection of Hidden Shellcode

Shellcode can be hidden inside objects that normally should not include executable code (e.g., images, movies, text documents, spreadsheets, etc.). An attacker could disguise the shellcode in such a way for several reasons, most commonly to evade detection, since some conventional security software avoid scanning such files. To detect such situations, some embodiments look for specific anomalies of the call stack. For instance, since the call stack deliberately references executable code, it would be highly unlikely to find a stack reference that points inside the memory image of a movie file or text document. Some embodiments therefore use such anomalous call stack references as indicators of malice.

Some embodiments analyze each stack reference to determine whether it points to inside the memory image of a non-executable file. The type of content of a data file may be determined for instance according to data structures used by the OS to allocate memory for the respective file. For instance, some embodiments check whether a respective region X of memory had been allocated for an image (JPEG, PNG, etc.), a document (PDF, DOCX, etc.), a media file (WAV, MP3, etc.), a compressed archive (ZIP, etc.), etc. Each type of content may be further identified by scanning the respective region of memory for a content-type signature comprising a particular format or arrangement of bits specific to that type of content. Exemplary content-type signatures are comprised of a fixed pattern of bits that uniquely identifies that content type. The respective pattern typically appears at the very beginning of the file, to assist the OS and other applications in determining the content type of the respective file. For example, portable document format (PDF) files begin with the signature sequence ‘% PDF’, while portable network graphics (PNG) files begin with the signature sequence ‘% PNG’. In contrast, signatures of a portable executable (PE) include ‘MZ’ and ‘PE\0\0’ (the letters P and E followed by two null bytes). Such signatures may be determined for each type of content and delivered to clients via software updates.

When a stack reference points to a memory image of a non-executable object, some embodiments determine that the respective object is used for hiding malicious code. The content of the respective object/memory region may then be sent to conventional anti-malware scanning.

ii. Detection of Generic Shellcode

Since shellcode is injected surreptitiously and therefore does not use the memory management facilities of OS 14, shellcode cannot make use of absolute references (i.e., references to hard-coded memory addresses). In contrast, clean code intended to be loaded into memory by OS 14 can include absolute memory references, since these can be relocated upon loading/linking, for instance, as described above. Also, code generated by just-in-time compilation (such as .NET or JavaScript) can include both absolute and relative references, since the compiler is aware of the local memory layout.

Some embodiments rely on the observation above for shellcode detection. For instance, analyzer 24 may determine whether code referenced by the stack contains absolute memory references or not; code that contains absolute references may be considered benign, whereas code that does not may be considered suspicious.

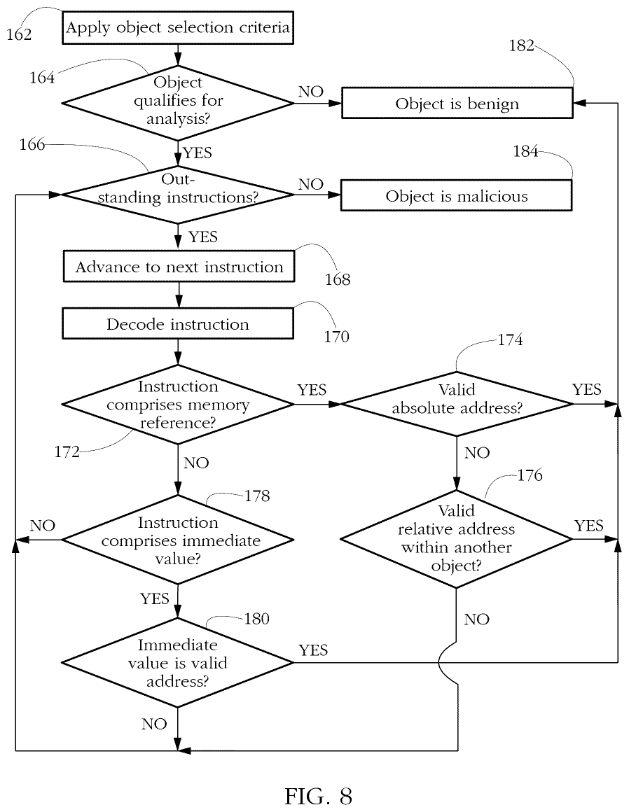

FIG. 8 shows an exemplary sequence of steps performed by state analyzer 24 to detect malicious shellcode according to some embodiments of the present invention. The illustrated method can be applied to any region of memory. However, as described above, some embodiments use the contents of the stack to efficiently select regions of memory for analysis. Some embodiments thus apply the method described in FIG. 8 to a target object comprising a code chunk pointed to by a stack reference (see step 108 in FIG. 3 and code chunk 42c pointed to by stack reference 32c in FIG. 4).

A sequence of steps 162-164 may determine whether the region of memory identified according to the current contents of the stack satisfies specific selection criteria for analysis. For instance, some embodiments only analyze code chunks that are not part of a loaded software module/library, preferring to use other methods to detect malicious DLLs (e.g., methods described above). In such embodiments, steps 162-164 may comprise determining the allocation type of the region of memory pointed to by the current stack reference (see e.g., region 44 in FIG. 4), and selecting the current target object for analysis only if the respective region of memory is not of type ‘image’. Alternatively or additionally, steps 162-164 may comprise determining a type of processor instruction that caused the current stack reference to be pushed onto the stack, and selecting the target object for analysis only if the respective instruction includes an indirect branch via a register (for example: CALL rax). In yet another exemplary embodiment, steps 162-164 may comprise identifying another call stack reference immediately following the current stack reference, and selecting the target object for analysis only if the other stack reference points to a region of memory of type ‘image’ (i.e., the target object invokes code from within a loaded library).

When the target object does not match criteria for analysis (step 164 returns a NO), a step 182 may determine that the object is benign. Alternatively, step 182 may determine that the target object does not comprise malicious shellcode, or refer the target object for analysis using other anti-malware tools and methods.

A sequence of steps 166-168 may then enumerate processor instructions in the target object/code chunk. A further step 170 may decode each instruction. Decoding may include decompiling or otherwise applying a set of manipulations to uncover the semantics of the respective instruction. Instruction semantics as well as decoding procedures may depend on platform and instruction set architecture.

In some embodiments, a step 172 determines whether the selected instruction includes a memory reference. Such determinations may use any method known in the art and various information about compilers and the specific hardware configuration of host system 10. If YES, a step 174 may determine whether the respective address is absolute, e.g.:
MOV rax, [0x00007FFF12346000],
and further whether the respective address is valid (i.e., points within a memory space allocated by OS 14 and belonging to an object that is currently in use). If step 174 returns a YES, some embodiments determine that the respective object is benign (a step 182), based on the observation that shellcode typically does not use absolute referencing.

If the current instruction references a relative address, e.g.:

MOV ESI, [RIP + 0x12345678], or
CALL 0x12345678,

some embodiments apply another set of heuristics to determine whether the respective instruction could have been created via just-in-time (JIT) compilation of legitimate code, such as JavaScript or .Net code. Such embodiments rely on the observation that JIT code occasionally uses relative addressing, so labelling all instructions that use relative memory addressing as malicious would result in an unacceptable rate of false positives. Instead, some embodiments explicitly test for a limited number of situations, i.e., a selected set of instructions that appear in JIT-compiled code.

In one such example, a step 176 may determine whether the memory reference included in the current instruction comprises a valid memory address located within a memory space allocated to another object distinct from the target object currently under analysis. If step 176 returns a YES, some embodiments determine that the target object is benign. Conversely, when the value included in the current processor instruction is neither a valid absolute address not a valid relative address, some embodiments advance to the next processor instruction.

A step 178 may determine whether the current instruction includes an immediate value (i.e., a numerical constant as opposed to a memory reference as above). One such example is given below:
MOV rsi, 0x00007FFF12346000.

If YES, in a further step 180 some embodiments may determine whether the respective immediate value comprises a valid memory address. If step 180 returns a YES, some embodiments conclude that the current instruction is part of legitimate code (e.g., code created via JIT compilation) and therefore the target object is benign.

To summarize the method illustrated in FIG. 8, some embodiments label a target code chunk as benign if it comprises at least one instruction that references a valid memory address (either via a memory reference or via an immediate value). Otherwise, a step 184 may determine that the target code chunk comprises malicious shellcode.

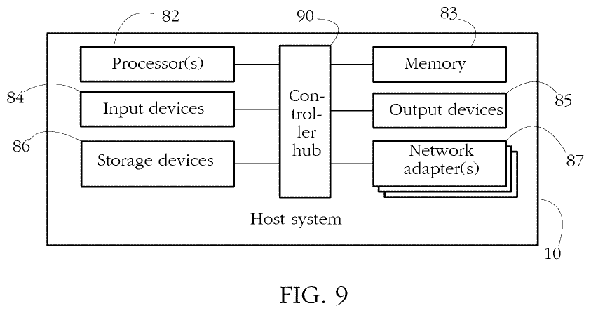

FIG. 9 shows an exemplary hardware configuration of a host system 10 programmed to execute some of the methods described herein. Host system 10 generically represents any electronic device executing software components shown in FIG. 1. The illustrated host system is a personal computer; other devices such as servers, mobile telephones, tablet computers, and wearables may have slightly different configurations.

Processor(s) 82 comprise a physical device (e.g. microprocessor, multi-core integrated circuit formed on a semiconductor substrate) configured to execute computational and/or logical operations with a set of signals and/or data. Such signals or data may be encoded and delivered to processor(s) 82 in the form of processor instructions, e.g., machine code.

Memory unit 83 may comprise volatile computer-readable media (e.g. dynamic random-access memory—DRAM) storing data/signals/instruction encodings accessed or generated by processor(s) 82 in the course of carrying out operations. Memory 83 is organized into pages, each page further comprising multiple individually addressable storage units. Input devices 84 may include computer keyboards, mice, and microphones, among others, including the respective hardware interfaces and/or adapters allowing a user to introduce data and/or instructions into host system 10. Output devices 85 may include display devices such as monitors and speakers among others, as well as hardware interfaces/adapters such as graphic cards, enabling the respective host system to communicate data to a user. In some embodiments, input and output devices 84-85 share a common piece of hardware (e.g., a touch screen). Storage devices 86 include computer-readable media enabling the non-volatile storage, reading, and writing of software instructions and/or data. Exemplary storage devices include magnetic and optical disks and flash memory devices, as well as removable media such as CD and/or DVD disks and drives. Network adapter(s) 87 enable host system 10 to connect to an electronic communication network and/or to other devices/computer systems.

Controller hub 90 generically represents the plurality of system, peripheral, and/or chipset buses, and/or all other circuitry enabling the communication between processor(s) 82 and the rest of the hardware components of host system 10. For instance, controller hub 90 may comprise a memory controller, an input/output (I/O) controller, and an interrupt controller. Depending on hardware manufacturer, some such controllers may be incorporated into a single integrated circuit, and/or may be integrated with processor(s) 82. In another example, controller hub 90 may comprise a northbridge connecting processor 82 to memory 83, and/or a southbridge connecting processor 82 to devices 84, 85, 86, and 87.

The exemplary systems and methods described herein are designed to prevent the most advanced malware attacks that target user-mode processes: exploits, code injections, privilege escalations, and evasion techniques, while minimizing the impact on system stability, performance, and user experience.

Some embodiments apply advanced security checks at selected moments/stages during the lifecycle of an executable entity, such as process creation or module loading. Such ‘inspection points’ are selected for being particularly informative of whether the respective entity is malicious or not. Stated otherwise, any malicious code is most likely to be present within the memory space of the respective entity and actually be executing at such inspection points. Therefore, by carrying out an analysis of the entity's memory space at the respective moment/stage, some embodiments can detect whether the current action of the respective entity took place in a malicious context, or if the respective entity has been compromised. For instance, some embodiments enable detecting whether a process is being spawned by shellcode, or if a library is being loaded by an infected process.

Conventional anti-malware solutions for monitoring user-mode software entities (processes and applications) typically rely on intrusive techniques such as hooking to detect various events indicative of the behavior of the respective entity. Hooking creates a risk to the stability of the host system and may negatively affect malware detection, for instance by contaminating the call stack of the monitored entity. In contrast, some embodiments of the present invention execute exclusively in kernel mode (ring 0 of processor privilege), does not use hooking, and does not inject any software into the monitored entities. Instead, embodiments rely on legitimate, documented OS features and functionality to intercept events and select inspection points. By operating primarily in kernel mode, embodiments of the present invention are also resilient against typical user-mode attacks.

Conventional security software may place a substantial computational burden on the host system, negatively affecting user experience and productivity. By judiciously choosing the most informative inspection points, some embodiments run the malware-detection routines only sporadically, thus minimizing the impact on performance.

Some embodiments further reduce computational costs and latency by relying exclusively on the content of volatile memory (e.g., RAM), as opposed to the content of non-volatile storage (e.g., disk files). For instance, some conventional security solutions detect malicious modifications of a software module/library by comparing the memory image of the respective module with the content of a disk file that the OS loader/linker uses to create the memory image. However, such methods require storage I/O operations, which are notoriously slow compared to access of volatile memory. In contrast, some embodiments rely exclusively on data residing in volatile memory, such as the memory image of the respective library and various metadata managed by the operating system.

Several conventional anti-malware methods rely on analyzing the memory space (e.g., memory snapshots/dumps) of a monitored entity. However, some entities load vast amounts of data into memory, and looking for indicators of malice therein amounts to searching for the proverbial needle in a haystack. In contrast, some embodiments rely on the observation that any malicious code executing in the vicinity of a selected inspection point is necessarily referenced by the call stack of the respective entity at the respective moment. Some embodiments therefore explicitly use stack references to efficiently identify target objects (e.g., individual code chunks, entire loaded modules, etc.) for analysis.

Some embodiments further reduce computational costs by targeting highly-specific memory locations for analysis. For instance, to detect module stomping, some embodiments determine a target memory address and an expected value that should be stored at the respective address according to memory relocation and/or exception handling data of a loaded module (e.g., according to a content of .RELOC and/or .PDATA sections of a portable executable). Some embodiments then compare the current value stored at the target address with the expected value, and conclude that a malicious modification has occurred if there is a mismatch.

Many modern security solutions rely on behavioral detection, for instance on detecting malware-indicative sequences of actions. However, advanced malware may be capable of changing its behavior to evade detection. Furthermore, there may be many ways of achieving the same malicious goal, e.g., injecting malicious code into a legitimately-loaded library. Behavioral anti-malware software may therefore struggle to keep up with a constantly evolving panoply of malicious behaviors. In contrast, some embodiments detect malware exclusively according to memory snapshots, relying on the observation that the various methods of infecting an executable entity are essentially different means to the same end, which is to somehow insert a chunk of malicious code into memory. Therefore, by efficiently analyzing the content of memory, some embodiments are able to counteract multiple types and variants of attack.

It will be clear to one skilled in the art that the above embodiments may be altered in many ways without departing from the scope of the invention. Accordingly, the scope of the invention should be determined by the following claims and their legal equivalents.

1. A computer system comprising at least one hardware processor configured to:
in response to an occurrence of a trigger event caused by an executing process, identify a region of memory used by the process, the region of memory identified according to a current content of a call stack of the process;
determine whether the region of memory is currently allocated for any software module used by the process;
in response, if the region of memory is not allocated for any software module used by the process, analyze a sequence of processor instructions stored within the region of memory to determine whether the sequence includes instructions referencing valid memory addresses; and
in response to analyzing the sequence, if the sequence does not include any instructions referencing valid memory addresses, determine that the region of memory stores malicious software.

2. The computer system of claim 1, wherein the at least one hardware processor is further configured, in response to determining that at least one instruction of the sequence references a valid memory address, determine that the region of memory stores benign software.

3. The computer system of claim 1, wherein analyzing the sequence of processor instructions comprises:
determining whether a selected instruction of the sequence includes a memory reference; and
in response to determining that the selected instruction includes the memory reference, determining whether the memory reference comprises a valid absolute address or a valid relative address located within a memory image of another software module.

4. The computer system of claim 1, wherein analyzing the sequence of processor instructions comprises:
determining whether a selected instruction of the sequence includes an immediate value;
in response, if yes, determining whether the immediate value comprises a valid memory address.

5. The computer system of claim 1, wherein the at least one hardware processor is further configured to:
in response to determining that the memory region is not allocated for any software module, determine a type of content that the memory region is allocated for; and
if the type of content does not comprise executable code, determine that the region of memory comprises malicious software.

6. The computer system of claim 5, wherein determining the type of content comprises scanning the region of memory for a content-type signature indicative of the type of content.

7. The computer system of claim 5, wherein determining the type of content comprises determining whether the region of memory stores an item selected from a group consisting of a document, a compressed archive, and a media file.

8. The computer system of claim 5, wherein determining the type of content comprises determining whether the region of memory stores an image of a portable executable (PE) file.

9. The computer system of claim 1, wherein the at least one hardware processor is configured to determine whether the region of memory is currently allocated for any software module according to an allocation type of the region of memory.

10. The computer system of claim 9, wherein the at least one hardware processor is configured to determine that the region of memory is currently allocated for a software module if the allocation type of the region of memory is ‘image’.

11. A computer security method comprising employing at least one hardware processor of a computer system to:
in response to an occurrence of a trigger event caused by an executing process, identify a region of memory used by the process, the region of memory identified according to a current content of a call stack of the process;
determine whether the region of memory is currently allocated for any software module used by the process;
in response, if the region of memory is not allocated for any software modules used by the process, analyze a sequence of processor instructions stored within the region of memory to determine whether the sequence includes instructions referencing valid memory addresses; and
in response to analyzing the sequence, if the sequence does not include any instructions referencing valid memory addresses, determine that the region of memory stores malicious software.

12. The method of claim 10, further comprising employing the at least one hardware processor to, in response to determining that at least one instruction of the sequence references a valid memory address, determine that the region of memory stores benign software.

13. The method of claim 10, wherein analyzing the sequence of processor instructions comprises:
determining whether a selected instruction of the sequence includes a memory reference; and
in response to determining that the selected instruction includes the memory reference, determining whether the memory reference comprises a valid absolute address or a valid relative address located within a memory image of another software module.

14. The method of claim 10, wherein analyzing the sequence of processor instructions comprises:
determining whether a selected instruction of the sequence includes an immediate value;
in response, if yes, determining whether the immediate value comprises a valid memory address.

15. The method of claim 10, further comprising employing the at least one hardware processor to:
in response to determining that the memory region is not allocated for any software module, determine a type of content that the memory region is allocated for; and
if the type of content does not comprise executable code, determine that the region of memory comprises malicious software.

16. The method of claim 15, wherein determining the type of content comprises scanning the region of memory for a content-type signature indicative of the type of content.

17. The method of claim 15, wherein determining the type of content comprises determining whether the region of memory stores an item selected from a group consisting of a document, a compressed archive, and a media file.

18. The method of claim 15, wherein determining the type of content comprises determining whether the region of memory stores an image of a portable executable (PE) file.

19. The method of claim 10, comprising determining whether the region of memory is currently allocated for any software module according to an allocation type of the region of memory.

20. The method of claim 19, comprising determining that the region of memory is currently allocated for a software module if the allocation type of the region of memory is ‘image’.

21. A non-transitory computer-readable medium storing instructions which, when executed by at least one hardware processor of a computer system, causes the computer system to:
in response to an occurrence of a trigger event caused by an executing process, identify a region of memory used by the process, the region of memory identified according to a current content of a call stack of the process;
determine whether the region of memory is currently allocated for any software module used by the process;
in response, if the region of memory is not allocated for any software modules used by the process, analyze a sequence of processor instructions stored within the region of memory to determine whether the sequence includes instructions referencing valid memory addresses; and
in response to analyzing the sequence, if the sequence does not include any instructions referencing valid memory addresses, determine that the region of memory stores malicious software.
